(19) United States
(12) Patent Application Publication
(10) Pub. No.: US 2019/0110630 A1
(43) Pub. Date: Apr. 18, 2019

(54) OVENS AND METHODS OF COOKING USING OVENS

(71) Applicant: Perlick Corporation, Milwaukee, WI (US)

(72) Inventors: Joey Kitabayashi, San Dimas, CA (US); Ronald Beil, Bellflower, CA (US)

(21) Appl. No.: 16/156,517

(22) Filed: Oct. 10, 2018

Related U.S. Application Data
(60) Provisional application No. 62/571,557, filed on Oct. 12, 2017.

(51) Int. Cl. A47J 27/10; F24C 3/12; F24C 15/16; A47J 36/32; A23L 5/10

(52) U.S. Cl. CPC A47J 27/10; F24C 3/128; A23V 2002/00; A47J 36/32; A23L 5/13; F24C 15/16

(57) ABSTRACT

An oven adapted for sous vide cooking is disclosed. The oven has an oven body defining an oven cavity and a heating element. The heating element is positioned within the oven and is controlled by a controlling element. A container having an outer wall defining a cavity adapted to receive liquid is placed upon a table within the oven cavity. A temperature sensor extends into the cavity adapted to receive liquid. The temperature sensor is in electrical communication with the controlling element and the heating element.

### CROSS-REFERENCE TO RELATED APPLICATION

This application claims priority under 35 U.S.C. § 119 to U.S. Provisional Patent Application No. 62/571,557, filed Oct. 12, 2017, entitled “Ovens and Methods of Cooking Using Ovens,” the entire contents of which are incorporated herein by reference all purposes.

### BACKGROUND

Sous vide cooking is a method of cooking in which food is vacuum-sealed in a plastic pouch and then placed in a heated water bath, which cooks the food over an extended period of time. In order to maintain a near constant temperature within the water bath to ensure that the food within the plastic pouches is cooked evenly, immersion circulators and heaters have been used. The immersion circulators and heaters are typically placed within the water bath to provide agitation and heat directly to the water within the water bath. This allows the water to maintain a near constant temperature, as the heater replaces any heat lost to the external environment and the circulator can quickly disperse the hotter water directly around the heating element to prevent any “hotspots” from forming within the water bath. The entire sous vide cooking process may endure for a number of hours or even days, and accordingly, precise and accurate temperature control is desirable.

While both immersion circulators and water baths have proven to be effective at performing sous vide cooking techniques, both of these systems require significant kitchen space (e.g., counter space and/or storage space) and access to an outlet or other power source, which may not be readily available in all kitchens. While some immersion heaters have been equipped with on-board battery power to alleviate the need for an external power source within the kitchen, these immersion heaters have a lower heat rating and are at times incapable of quickly raising a water bath to the necessary cooking temperature. These drawbacks have prevented sous vide cooking from achieving widespread acceptance in residential applications.

### SUMMARY

Some aspects of the disclosure provide an oven configured to carry out the sous vide cooking process. The oven can accurately and precisely control the temperature of a water bath over an extended period of time while having a reduced kitchen footprint. The oven can produce a desired sous vide cooking temperature in a timely manner and is less prone to environmental losses during the cooking process.

Some aspects of the present invention provide an oven adapted to perform a sous vide cooking process. The oven has an oven body defining an oven cavity. A heating element is positioned within the oven and is controlled by a controlling element. A container is positioned upon a table within the oven cavity. The container can has an outer wall defining a cavity adapted to receive liquid. A temperature sensor extends into the cavity adapted to receive liquid. The temperature sensor is in electrical communication with the controlling element and the heating element. The table is configured to rotate within the oven cavity.

Some aspects of the invention provide methods of sous vide cooking within an oven. The oven defines an oven cavity that is heated by a heating element. The heating element is in communication with a controlling element. The method includes measuring a water temperature of water within a container in the oven cavity using a temperature sensor. The temperature sensor can be in communication with the controlling element. The method can also include comparing the measured water temperature to a target water temperature that is provided to the controlling element. The method can further comprise adjusting an operational parameter of the heating element based upon a calculated difference between the measured water temperature and the cooking water temperature. In some aspects, the method further comprises agitating the water within the container.

These and other features of the present disclosure will become more apparent from the following description of the illustrative embodiments.

### DESCRIPTION OF THE DRAWINGS

FIG. 1 is a front view of an oven incorporating a rotatable table according to one aspect of the disclosure.

FIG. 2 is an exploded view of sous vide cooking assembly components present in the oven of FIG. 1.

FIG. 3 is an exploded view of an assembly configured to rotate the rotatable table of FIG. 2.

FIG. 4A is a top perspective view of a turntable that can be a part of the sous vide cooking assembly of FIG. 2.

FIG. 4B is a bottom perspective view of the turntable of FIG. 4A.

FIG. 5 is a schematic view of an alternative aspect of a containment system that can be incorporated into the sous vide cooking assembly of FIG. 2.

FIG. 6 is a schematic view of an alternative aspect of a containment system that can be incorporated into the sous vide cooking assembly of FIG. 2.

FIG. 7 is a process diagram of a sous vide cooking process that may be performed using the oven of FIG. 1.

Corresponding reference characters indicate corresponding parts throughout the several views. Although the drawings represent embodiments of the present invention, the drawings are not necessarily to scale and certain features may be exaggerated in order to better illustrate and explain the embodiments of the present disclosure.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

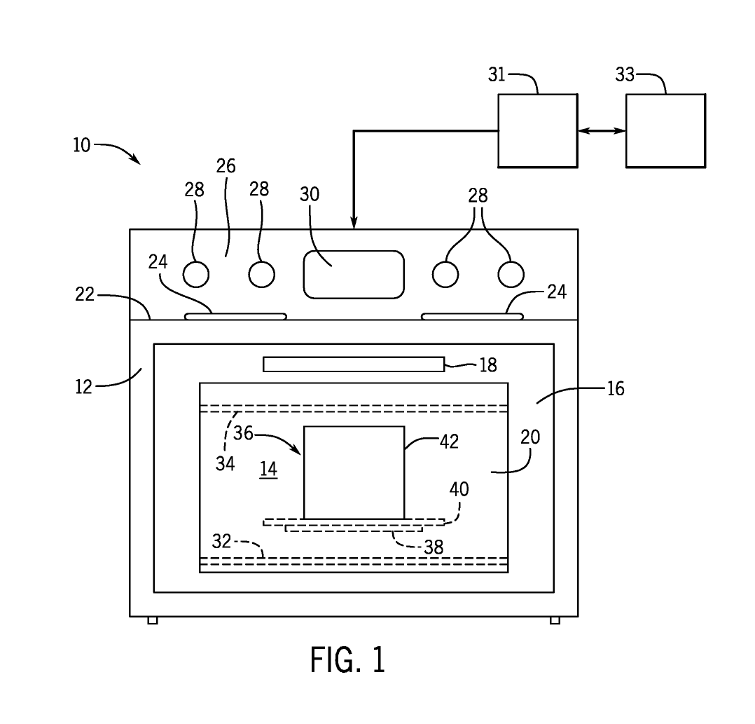

FIG. 1 illustrates an oven 10 according to an aspect of the invention. For example, the oven 10 can be an electric oven, gas oven, dual fuel oven, convection oven, or other type of range or oven. The oven 10 has an insulated body 12 surrounding a cavity 14 that is heated by one or more heating elements (not shown). The oven 10 can have a door 16 that rotates or otherwise translates between a closed position and an open position to selectively permit access into the cavity 14 of the oven 10. In some configurations, the door 16 also includes a handle 18. The handle 18 may be placed in a position near a top of the door 16 and opposite a hinge coupling a bottom of the door 16 to the body 12. The door 16 can rotate about the hinge, selectively allowing access into the oven cavity 14 depending upon the angular position of the door 16. In some configurations, the door 16 may have a transparent or translucent window 20 extending through the door 16 to allow at least some visual inspection of the cavity 14 when the oven door 16 is closed.

The oven 10 may have a cooktop 22 including one or more burners 24. For example, the one or more burners 24 may be gas burners, such as the gas burners shown and described in U.S. application Ser. No. 15/726,742, entitled “High Output Gas Burner and Range,” which is hereby incorporated by reference in its entirety for all purposes. Alternatively, the one or more burners 24 can be electric burners, such as induction burners or resistance burners. The one or more burners 24 can be controlled by knobs 28 present on a control panel 26 extending above, below, or outward from the cooktop 22. In some configurations, each burner 24 present on the cooktop 22 can be independently controlled by a separate knob 28. The knobs 28 can be rotatably adjustable so that the angular position of the knob 28 can correspond with a desired burner output of the burner 24 the knob is in electrical or mechanical communication with. Alternatively, the one or more knobs 28 can be omitted from the control panel 26, and the entire cooktop surface may be controlled by inputs within a display 30. The display 30 can be a light emitting diode (LED) display, liquid crystal display (LCD), or organic light emitting diode (OLED) display, for example. In some configurations, the display 30 is a touch screen configured to receive input from a user. The display 30 may also be accompanied by a plurality of depressible buttons (not shown) or knobs 28 configured to produce different oven functionalities (e.g., types of cooking, temperature adjustments, clock settings, etc.) that can be selected by a user.

The display 30 can be in electrical communication with a processor or one or more controllers 31 (hereinafter “controlling elements”) which can communicate with one or more heating elements to heat the oven cavity 14. The controlling elements 31 may control the heating elements to produce a number of different cooking processes, temperatures, and settings based upon input received from a user. For example, the display 30 may provide a user with the ability to choose between cooking processes such as “broil,” “bake,” “warm,” “boil,” simmer,” or “sous vide,” for example. The display 30 may also prompt a user to select a setting, such as “high,” “low,” or a desired temperature of the oven cavity 14 (e.g., “bake” at 425 degrees F., “broil” at 550 degrees F., “sous vide” at 150 degrees F., etc.) that will be used to cook a product for a period of time. The controlling elements 31 will then command one or more burners 24 or heating elements within the oven cavity 14 to adjust an energy output to achieve the user-entered parameters. In some configurations, the controlling elements 31 will initiate an alarm when the desired cooking parameters are present within the oven cavity 14. For example, an alarm may sound when the oven 10 is adequately preheated for a baking process.

In some configurations, the oven 10 can be a convection oven. The oven 10 can have a circular heating element (not shown) located on the rear wall of the oven 10, behind a baffle (not shown). A fan (not shown) contained within the center of the heating element can be used to distribute heat produced by the heating element to the cavity 14. Air can be heated and immediately and continuously distributed evenly throughout the cavity 14 by the fan, which circulates air about the entire oven cavity 14 to avoid hot spots. In some configurations, the oven 10 can hold oven temperatures within the cavity within about 1-2 degrees F. of a target temperature.

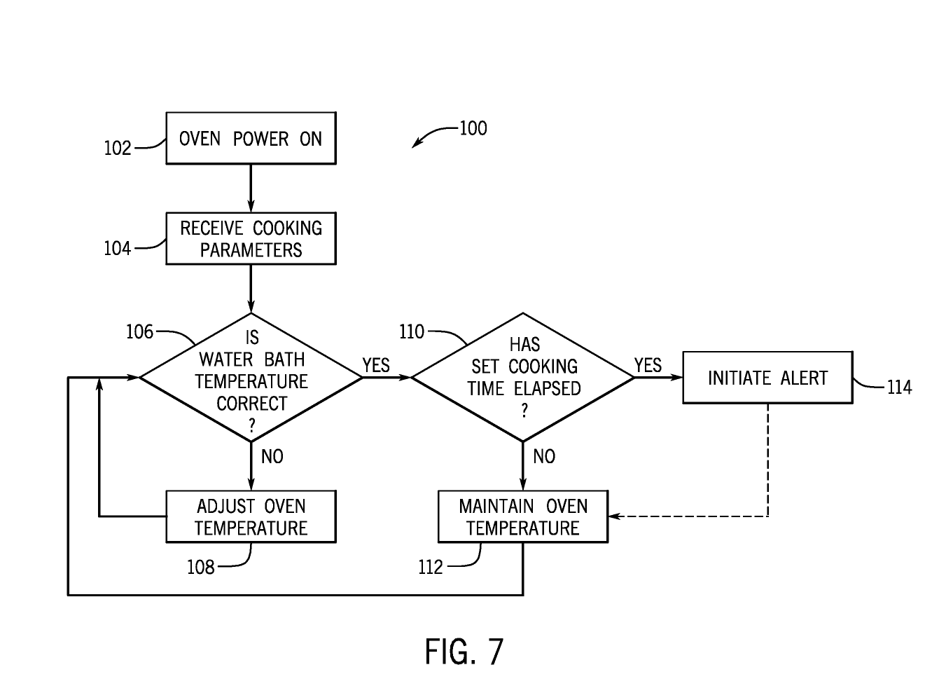

In some configurations, one or more heating elements (not shown) can be positioned about the oven cavity 14. For example, heating elements can be placed on each side of the cavity 14, including the back of the cavity 14. Heating elements may be positioned about the cavity 14 to perform different oven functions. A heating element positioned near a top wall of the cavity 14 may be configured to broil food (i.e., it will activate when the oven 10 is performing a “broiling” process), while other elements spaced about the walls of the cavity 14 may be configured to operate during baking or other processes, such as the sous vide process 100 described below with reference to FIG. 7. The controlling elements 31 in communication with the display 30 can also be in electrical communication with the one or more heating elements, and may be configured to adjust the heat output of the heating elements based upon user inputted parameters. For example, if a user selects a “broil” function on the oven, it may signal that the upper heating element may need to both activate and achieve a certain operational parameter (i.e., heat intensity).

One or more sensors (not shown) can also be placed within the oven cavity 14 to measure the ambient temperature of the cavity 14. The controlling elements 31 can compare the measured ambient temperature of the cavity 14 with a desired user-inputted temperature and adjust an operational parameter of the heating elements based upon the calculated difference between the desired temperature and the measured ambient temperature of the cavity 14. The operational parameter to be adjusted can be the heat element power, the intensity at which the heating element is operating, or other parameters that may affect the internal air temperature of the cavity 14. If the calculated difference between measured ambient temperature and desired temperature falls within a set tolerance (e.g., less than 5° F., less than 1° F., or otherwise), the controlling elements 31 may also maintain the operational parameters of the heating elements present within the oven 10. In some configurations, the plurality of heating elements can be configured to cycle during oven 10 operation to evenly distribute heat about the cavity 14. Optionally, one or more heating elements may be positioned outside of the cavity and one or more fans or other blowing devices (not shown) are configured to direct heat produced by the one or more heating elements into the cavity 14 using forced air.

In some configurations, the display 30 may prompt a user to select a cooking time to carry out the process. The display 30 may then display a timer, so that a user can be made aware of the time remaining in the cooking process as it remains ongoing. When the timer expires, the controlling elements 31 can initiate an alarm that audibly or visually alerts a user that the selected cooking time has elapsed. In some configurations, the one or more heating elements present within the oven cavity 14 can be configured to turn off when the cooking timer expires. The heating element(s) can also continue operating, even once a predetermined cooking time has elapsed. This may be the case particularly when the oven is performing sous vide cooking processes.

The controlling elements 31 and/or display 30 of the oven 10 can also be placed in electrical communication with an internal or external memory 33. The memory 33 can store various cooking processes and recipes. In some configurations, the memory 33 can be accessed and/or supplemented with outside databases of information such as, for example, the internet, a smart-phone, a computer, or a cloud-based memory that may have access to a plurality of different recipes or cooking processes. Accordingly, a user may be able to access a recipe from a remote device and display the recipe on the display 30. In some configurations, a user may be able to browse the internet via the display 30 to review different recipes that might be of interest to a user. When a recipe or cooking process is accessed and then selected by a user, the recipe or cooking process may then provide instructions to the heating elements within the oven 10 to produce a specific cooking process and temperature, and may also set the timer. In some configurations, the display 30 can visually produce the list of ingredients used for the recipe, so that a user may be able to quickly and effectively assemble the necessary ingredients for the recipe without the use of paper or a separate device, like a phone or computer. The display 30 may provide an ingredient checklist, so that a user can further interact with the display 30 and ensure that ingredients are not forgotten or added multiple times, which could otherwise make the recipe unsuccessful.

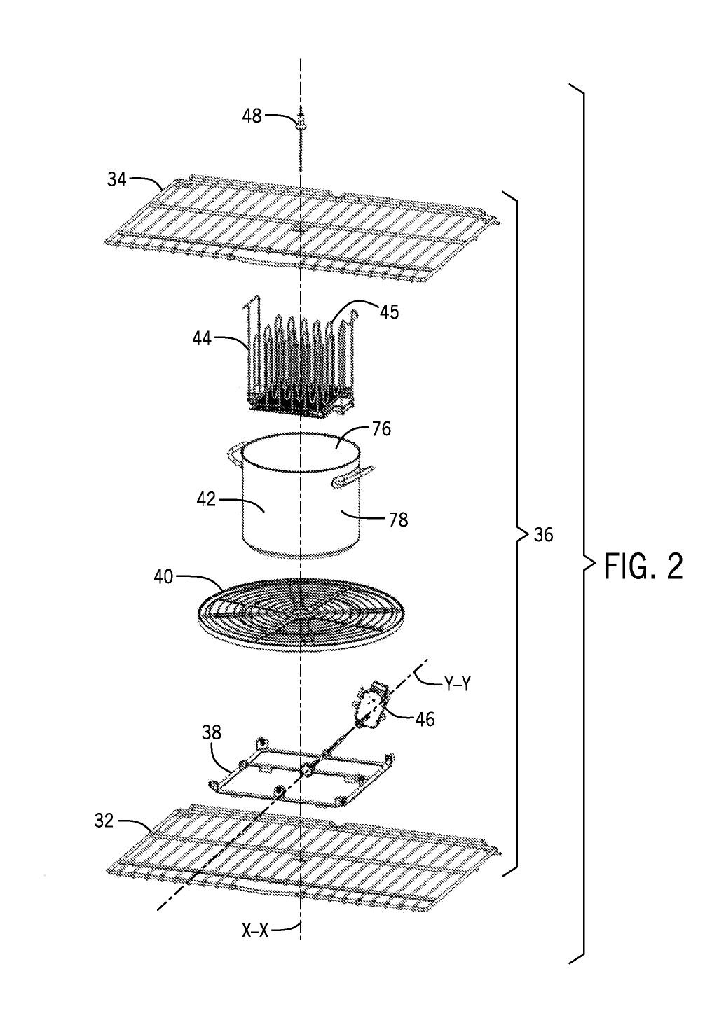

One or more racks 32, 34 can be spaced apart in the oven cavity 14. For example, a lower rack 32 and an upper rack 34 can provide two separate platforms to support pots, pans, other cooking utensils, or food in a constant position during a cooking process. The racks 32, 34 may have a wire grate configuration, as shown in FIG. 2. In some configurations, the racks 32, 34 are removably coupled to the inside wall of the cavity 14, and may be readily movable between different positions in the cavity 14. For example, if a user wanted the oven 10 to perform a broiling process, the upper rack 34 may advantageously be moved closer toward the top of the cavity 14. Food placed upon the upper rack 34 may then be positioned closer to a broiling heating element at a top of the cavity 14 to speed up the cooking process. If a user wanted the broiling process to be performed more slowly, the upper rack 34 may be optionally moved downward, away from the broiling heating element. In some configurations, the racks 32, 34 may be removed from the cavity 14 entirely.

FIGS. 1 and 2 illustrate a sous vide cooking assembly 36. The sous vide cooking assembly 36 can be used to perform an accurate and effective sous vide cooking process within the oven cavity 14, such as the process 100 described below with reference to FIG. 7. In some configurations, the sous vide cooking assembly 36 includes a turntable support 38 that supports and rotates a turntable 40. The turntable 40 can be removably received upon the turntable support 38, where it may then be rotated relative to the turntable support 38 about an axis X-X. For example, the turntable 40 can be removed for cleaning or other maintenance, if necessary. A motor 46 positioned outside the cavity 14 can be used to input a rotational force to a shaft 50 in communication with the turntable support 38. The rotational force imparted on the shaft 50 can cause the turntable 40 to rotate about the axis X-X, perpendicular to the longitudinal axis Y-Y of the shaft 50. In other configurations, the motor 46 is positioned below the cavity 14 and provides a rotational force directly to the turntable 40. In such configurations, the turntable 40 and shaft 50 can rotate approximately coaxially.

In some configurations, the motor 46 is configured to produce a shaft angular velocity of between about 1 rpm and about 30 rpm. The shaft 50 angular velocity may produce a turntable 40 velocity between about 1 rpm and about 30 rpm, which can agitate and mix liquid contained within a container 42. For example, one implementation may include an RPM of between 1.8 and be effective to 18 RPM. The motor 46 can be an AC motor, DC motor, universal motor, or other type of motor configured to translate angular motion to the shaft 50. In some configurations, the motor 46 can be configured to produce a constant angular velocity. The motor 46 can also be coupled to a variable speed drive (not shown) that varies the angular velocity of the motor 46 based upon the needs of a user. For example, there may be different shaft 50 and turntable 40 angular velocities used to achieve different cooking processes. A “sous vide” setting in the oven 10 might employ a turntable 40 speed between about 3 rpm and about 18 rpm, while a “bake” setting might employ a turntable 40 speed of about 3 rpm. In other configurations, there may be multiple “sous vide” settings that are each assigned a turntable 40 angular velocity. In still other configurations, the motor 46 is used to provide agitation to liquid contained within in the container 42 in other ways. For example, the turntable 40 may remain stationary within the oven cavity 14 and the motor 46 can drive rotation of an impeller or other liquid agitating device received within the container 42. In still other configurations, the motor 46 can be omitted and a different mechanical liquid mixing device, such as a magnetic stir-stick, can be placed within the container 42 filled with liquid to agitate the liquid. In some configurations, the motor can also be reversible.

The motor 46 can be placed in electrical communication with the display 30 and the controlling elements 31. In some configurations, the motor 46 provides an angular velocity to the shaft 50 at all times when the oven 10 is being heated by one or more heating elements. In other configurations, the motor 46 is configured to operate only during certain selected cooking processes, which can be selected by a user. For example, the motor 46 may optionally remain inactive if a “broil” setting is selected, but may activate when a “bake” or “sous vide” option is selected. In some configurations, the operation of the motor 46 may be influenced by the position of the door 16. For example, when the door 16 is in a closed position (and the cavity 14 is being heated), the motor 46 may operate. If a user opened the door 16, a motor override may be tripped that blocks current to the motor 46 and prevents the motor 46 from rotating, causing the turntable 40 to cease rotation. The motor override may allow a user to adjust or remove containers, vessels, food, or other materials within the cavity 14 that may be on the turntable 40 easily, as they will no longer be moving. When the door 16 is returned to a closed position, current to the motor 46 can be restored and the turntable 40 may continue rotating.

In other configurations, operation of the motor 46 can be controlled by a dedicated switch. The control panel 26 may include one or more depressible buttons that control the rotation of the motor 46. For example, a push button switch could allow a user to turn the motor on and off. During a cooking process, a user could depress the push button to cease rotation of the motor 46 (and the turntable 40) so that food could be checked on or removed from the oven cavity 14 easily. If the cooking process should continue, the user can then depress the push button a second time to restore rotation to the motor 46 and turntable 40. In some configurations, a knob 28 or the display 30 can also be used to control motor 46 operation in a similar fashion to the push button switch.

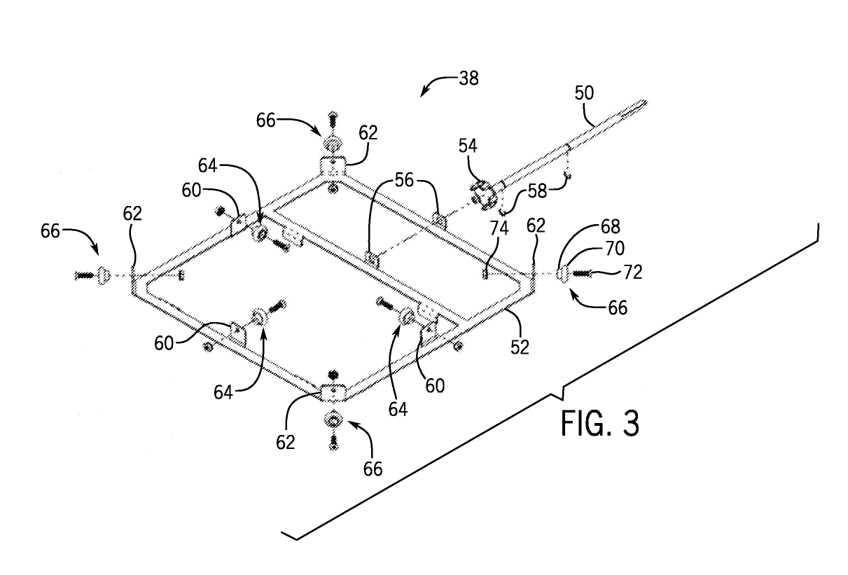

The turntable support 38 is shown in additional detail in FIG. 3. As explained above, the turntable support 38 has a shaft 50 which can be mechanically coupled to the motor 46. A transmission may be included between the motor 46 and shaft 50 that causes the shaft 50 to rotate at a higher or lower angular velocity than an output shaft of the motor 46. In some configurations, the turntable support 38 can be located within the cavity 14 of the oven 10 at a position between the one or more racks 32, 34. For example the turntable support 38 may be vertically centered within the cavity 14. In other configurations, the one or more racks 32, 34 can be removed and the turntable support 38 may be positioned near the bottom of the cavity 14. In still other configurations, the turntable support 38 may be supported by the lower rack 32 or upper rack 34, and may rest upon the lower rack 32 or the upper rack 34.

The shaft 50 can be coupled to a frame 52, which can support the turntable 40. In some configurations, the frame 52 has a substantially square shape that stabilizes the turntable 40 and evenly distributes any loading (e.g., from a container 42, food, or other items placed upon the turntable 40) experienced by the frame 52. The frame 52 can be made of stainless steel, aluminum, or other materials suitable for use in cooking environments that are also rigid enough to support typical loading that may be present on the turntable 40. The frame 52 can be coupled to the cavity 14 in a number of ways. For example, the frame 52 can extend outward to form a rigid coupling with each of the side walls and the rear wall of the cavity 14. In other configurations, one or more support arms coupled to the one or more walls in the cavity 14 extend inward to support the frame 52. In yet other configurations, the frame 52 is coupled to a stand extending from a bottom of the frame 52 towards the lower wall of the cavity 14, which provides adequate support to one or more containers, food, or other items that may be present on the turntable 40.

In some configurations, the shaft 50 is rotatably coupled to the frame 52. The shaft 50 may extend through one or more shaft supports 56 coupled to the frame 52. The shaft supports 56 can have thru-holes sized to receive the shaft 50 there through. Bearings 58 may also be received within the thru-holes in the shaft supports 56. The bearings 58 may be sized to form an interference fit with the thru-holes in the shaft supports 56, so that a semi-rigid coupling is formed once the bearings 58 are properly installed into the shaft supports 56. The bearings 58 may reduce the amount of friction and wear experienced by the shaft 50 as it rotates to move the turntable 40.

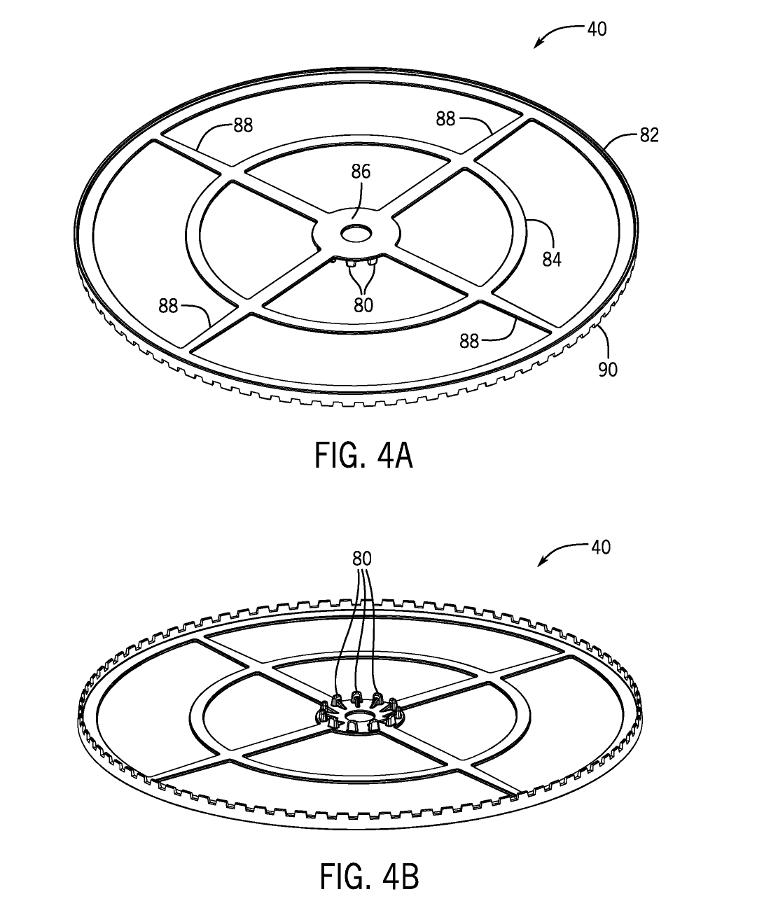

In some configurations, a bevel gear 54 is coupled to a distal end of the shaft 50. The bevel gear 54 can translate the angular motion of the shaft 50 about axis Y-Y to angular motion of the turntable 40 about axis X-X (see FIG. 2). The turntable 40 may have a second bevel gear (formed of teeth 80, shown in FIG. 4B) configured to mate with the bevel gear 54 to provide rotation to the turntable 40. The gear ratio between the bevel gear 54 and the second bevel gear may be approximately 1:1, although gear ratios larger or smaller may be used as well. While the shaft 50 has been described as having a bevel gear 54 configured to translate angular motion about the axis Y-Y perpendicularly to angular motion about the axis X-X, other methods of transmitting rotational force along a perpendicular axis may be used instead. For example, the shaft 50 and turntable 40 may comprise a worm drive, where the shaft 50 operates as a worm and the turntable 40 comprises a worm gear.

Motors 46 having vertical output shafts may also be used, and the shaft 50 may extend vertically upward toward the frame 52. In some configurations, a distal end of the shaft 50 may be rigidly or removably coupled to the turntable 40 so that both the shaft 50 and turntable 40 rotate about the axis X-X or an axis parallel to the axis X-X. In still other configurations, the shaft 50 can be coupled to the motor 46 via a belt drive positioned below the cavity 14. The shaft 50 may extend upwardly into the cavity 14, where it may be coupled to the turntable 40, thereby causing the turntable 40 to rotate about the axis X-X.

In some configurations, the frame 52 includes a plurality of turntable guides 60, 62 extending upward from the frame 52. In some configurations, a first plurality of turntable guides 60 extend upwardly from an interior of the frame 52. The first plurality of turntable guides 60 can be positioned to contact or otherwise constrain the motion of the turntable 40 by each directing a radial surface of the turntable 40. In some configurations, each of the first plurality of turntable guides 60 are spaced about the frame 52 radially equidistant from a center of the frame 52 so that each of the first plurality of turntable guides 60 direct the same radial surface of the turntable 40 simultaneously. In other configurations, the turntable guides 60 themselves do not contact or otherwise guide the turntable 40 when it is positioned above the frame 52, but instead support one or more rollers 64 positioned to contact and direct the turntable 40 as it rotates relative to the frame 52.

A second plurality of turntable guides 62 can also extend upward from the frame 52. For example, the second plurality of turntable guides 62 can extend upwardly from an exterior of the frame 52. In some configurations, the second plurality of turntable guides 62 may form an outer perimeter of the frame 52, and can contact or otherwise constrain motion of the turntable 40 by each directing a radial surface of the turntable 40. In some configurations, each of the turntable guides 62 are spaced about the frame 52 radially equidistant from a center of the frame 52 so that each of the second plurality of turntable guides 62 direct the same radial surface of the turntable 40 simultaneously. In configurations of the frame 52 that have a substantially square shape, a turntable guide 62 may extend upward from each corner of the square shape, as shown in FIGS. 2 and 3. One or more rollers 66 can be coupled to the turntable guides 62 and may support and rotate in concert with the turntable 40 as it is angularly displaced by the shaft 50 and the bevel gear 54.

The rollers 64, 66 can be spaced about the frame 52 to both support and balance the turntable 40 as it rotates. The rollers 64, 66 can be formed of ceramic, stainless steel, aluminum, high-performance plastics, or other materials capable of providing sufficient corrosion resistance while being able to withstand high temperatures. In some configurations, the rollers 64, 66 each have a first section 68 and a second section 70 spaced apart from the first section 68. In some configurations, the first section 68 is defined by a diameter smaller than the diameter defining the second section 70. The first section 68 may be configured to engage a surface of the turntable guides 60, 62, while the second section 70 may be configured to contact and support the turntable 40 when it is present within the oven cavity 14. Each of the rollers 64, 66 may be coupled to a turntable guide 60, 62. A bolt 72 can extend through a bore within the rollers 64, 66 and an aperture within the turntable guide 60, 62, where it can be threadably connected to a nut 74. In some configurations, the nut 74 engages a surface of a turntable guide 60, 62 when it is properly installed and tensioned. The bolt 72 can be chosen to form a clearance fit with both the aperture in the turntable guide 60, 62 and the bore within the roller 64, 66 so that the roller 64, 66 can still freely rotate about an axis defined by the bolt 72.

Referring now to FIGS. 4A and 4B with continued reference to FIGS. 2 and 3, the turntable 40 is shown. The turntable 40 can be placed on the frame 52, where it can then rotate to agitate water within the water bath 42. In some configurations, the turntable 40 is centered over the frame 52 and is placed in mechanical communication with the bevel gear 54. The center of the turntable can include a plurality of angled teeth 80 that mesh with the bevel gear 54. As the motor 46 operates and rotates the shaft 50, the angled teeth 80 meshed with the teeth on the bevel gear 54 rotate, causing the turntable 40 to rotate about the axis X-X. The underside of the turntable 40 may also engage one or more rollers 64, 66 present on one or more turntable guides 60, 62. The friction between the turntable 40 and the rollers 64, 66 may cause the rollers 64, 66 to rotate about the bolts 72 as the turntable 40 rotates.

In some configurations, the turntable 40 provides a surface to support a container 42, which can contain water, food, or a combination of the two. In some configurations, the turntable 40 is defined by a substantially circular outer perimeter 82. The turntable 40 can include an array of circular platform surfaces 84, 86 extending circumferentially around the turntable 40 and connected by one or more radial platforms 88. In some configurations, the circular platform surfaces 82, 84, 86 are positioned close enough together to support a container 42, while still being spaced apart enough to allow certain foodstuffs or other items to pass through. In other configurations, the turntable 40 has a substantially flat, continuous surface designed to receive and support the container 42. The turntable 40 can be positioned within the oven 10 to allow for unobstructed rotation within the cavity 14. For example, the turntable 40 can have a diameter smaller than a length or width of the cavity 14, and can be centered within the cavity 14. Accordingly, the turntable 40 would not contact any walls within the cavity 14 that may prevent consistent rotation within the cavity 14. In some configurations, the outer perimeter of the turntable 40 comprises a plurality of notches 90.

The container 42 shown in FIG. 2 can be considered a water bath when it contains water. Any vessel capable of storing a volume of water suitable for sous vide cooking can constitute the container 42. For example, the container 42 may be a stock pot, as shown in FIG. 2. In some configurations, the container 42 has a cavity 76 defined by an outer surface 78. The cavity 76 can receive and store a volume of water, which can be used for sous vide cooking. The outer surface 78 of the container 42 may be defined by a diameter smaller than the diameter defining the outer perimeter 82 of the turntable 40. The container 42 can be removable from the turntable 40 (and cavity 14) and can also be interchangeable with multiple different containers 42, depending on user needs.

In some configurations, a food containment system 44 is received within the cavity 76 of the container 42. The food containment system 44 may be a rack that is removably or rigidly coupled to the container 42 and can be partially submerged in water present in the container 42. The food containment system 44 can receive food and keep that food at a proper level of submersion within the container 42. The food containment system 44 can have a number of fins 45 or baffles that agitate water. In some configurations, the food containment system 44 can be coupled to the container 42 and can rotate in concert with the container 42 and the turntable 40 during a sous vide cooking process. In other configurations, the food containment system 44 can be coupled to an upper rack 34, which may allow the food containment system 44 to remain stationary within the container 42 as the container 42 rotates during turntable 40 rotation. The relative rotation between the container 42 and the fins 45 of the food containment system 44 may agitate the water and promote a homogenous temperature distribution throughout the entire container 42. Optionally, the food containment system 44 can be rotated about the container 42 while the container 42 remains stationary during the sous vide process. In some configurations, the food containment system 44 and a temperature sensor 48 can be received within the container 42 concurrently.

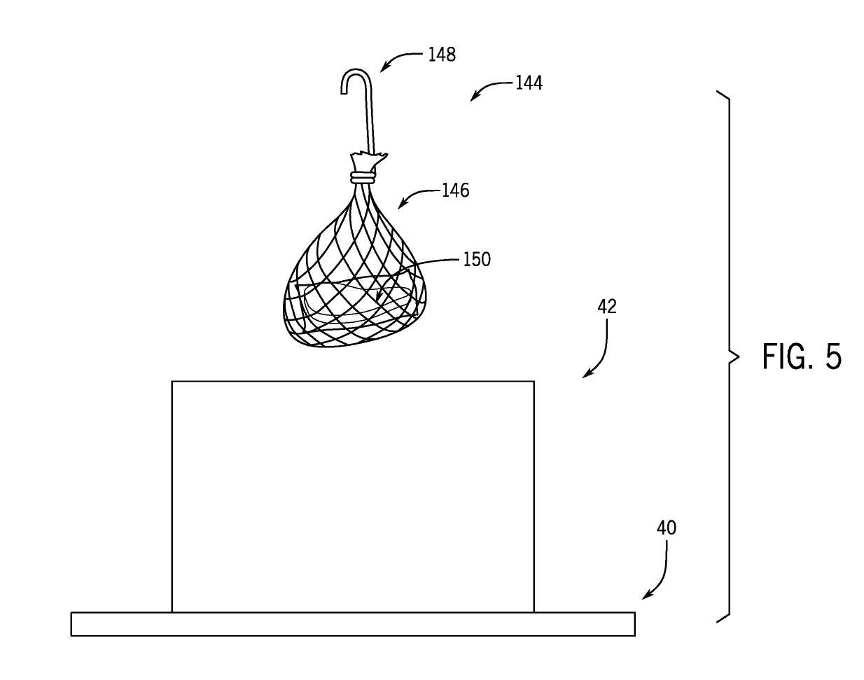

FIG. 5 shows an alternative food containment system 144 that can be used in the sous vide cooking assembly 36. The food containment system 144 can comprise a bag 146 formed of a water permeable material or a material having an orientation that allows water to freely enter into the bag 146. In some configurations, the bag 146 is formed of a stainless steel wire mesh that allows movement of water through the bag 146 to contact a vacuum-sealed pouch of food 150 contained within its interior. The bag 146 can be removably coupled to a hook 148. In some configurations, the hook 148 is removably coupled to the upper rack 34 within the cavity 14 to suspend the bag 146 and food 150 within the water bath 42 during the sous vide cooking process. In some configurations, the relative motion between the water bath 42 and the stationary bag 146 can agitate the water within the water bath 42 to homogeneously distribute the temperature of the water throughout the water bath 42. The temperature sensor 48 can be suspended in the water bath 42 concurrently with the bag 146. When the cooking process is complete, a user can unhook the hook 148 from the upper rack 34 and remove the bag 146 and food 150 from the cavity 14.

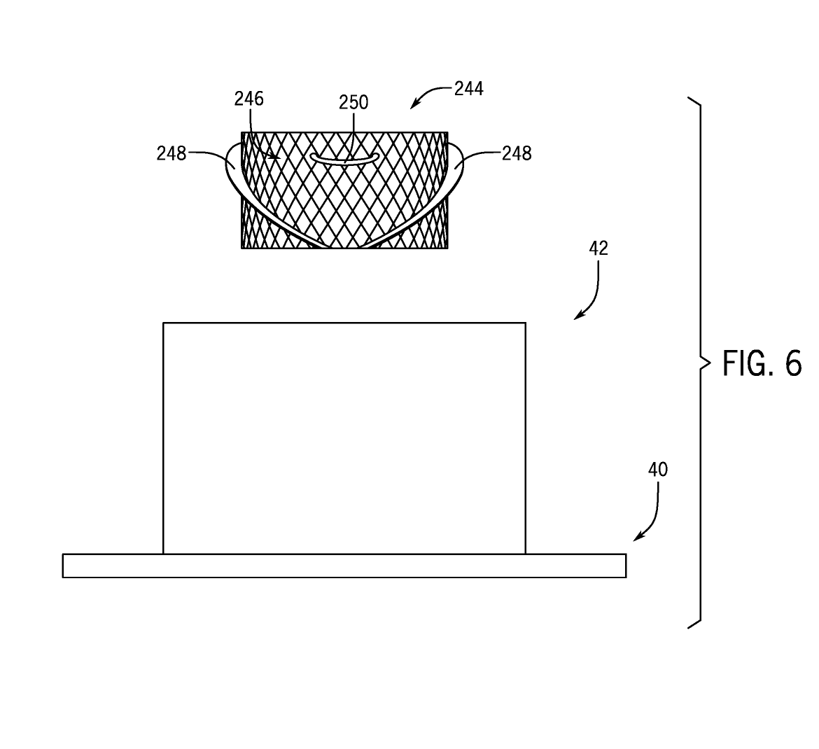

FIG. 6 shows a second alternative food containment system 244 that can be used in the sous vide cooking assembly 36. In some configurations, the food containment system 244 is suspended and at least partially submerged within the water bath 42 during the sous vide cooking process. For example, one or more hooks (not shown) can be coupled to both the upper rack 34 and one or more handles 250 on the containment system 244. The containment system 244 can have a basket 246 made of water permeable material or water permeable material orientations. For example, the basket 246 may be formed of wire mesh. The basket 246 can hold one or more vacuum-sealed pouches of food (not shown) that can be contacted by water within the water bath 42 during the sous vide cooking process. One or more blades 248 can extend around the outside of the basket 246. In some configurations, the blades 248 extend helically or arcuately about the outside of the basket. During the sous vide cooking process, the containment system 244 may stay relatively stationary while the water bath 42 rotates in concert with the turntable 40. The blades 248 can contact the water within the water bath 42, causing the water to displace and mix throughout the entire water bath 42 and evenly distribute the water temperature about the water bath 42. In some configurations, the blades 248 can extend in either direction about the outer surface of the basket 248. The temperature sensor 48 and basket 246 can be suspended within the water bath 42 concurrently.

The temperature sensor 48 can be received within the cavity 76 of the container 42. In some configurations, the temperature sensor 48 measures a temperature of the fluid contained within the container 42. For example, the temperature sensor 48 may measure the temperature of water contained within the water bath 42 during a sous vide process. The temperature sensor 48 may be a thermometer, thermocouple, infrared sensor, or a resistive temperature device (RTD), for example. The measuring accuracy of the temperature sensor 48 may be within about five degrees, within about a single degree, within about a tenth of a degree, or may be otherwise chosen to adequately measure the temperature of the water within the container 42 to perform a sous vide process. The temperature sensor 48 may be placed in electrical communication with the controlling elements 31 within the oven 10. In some configurations, the controlling elements 31 adjust operational parameters of the heating elements based upon measurements taken by the temperature sensor 48.

In some configurations, the temperature sensor 48 can also serve as a meat temperature probe. The temperature sensor 48 can extend downward from a top of the oven cavity 14, and can be inserted into food that is to be cooked by the oven 10. The temperature sensor 48 can then communicate with the controlling elements 31 of the oven 10 to alter the heating elements based upon measured temperatures. For example, once the temperature sensor 48 detects a target temperature within the food (e.g., a ribeye steak measured at 145 degrees F.), the controlling elements 31 of the oven 10 may signal to the heating elements to cease operation.

Referring now to FIG. 7, a process for sous vide cooking 100 is provided. As will be explained, the sous vide cooking process 100 uses and alternates the ambient oven cavity 14 temperature to accurately control the temperature of water present within the cavity 76 of the container 42 over a period of time. As the container 42 contains water during the process, it is described herein as a water bath. The process 100 may be performed by the oven 10, for example.

Beginning at block 102, the oven 10 may be first turned on. In some configurations, turning the oven on constitutes activating one or more of the heating elements present within the oven 10. The oven 10 may be turned on in a number of different ways. For example, a user may use the display 30 or one or more buttons on the control panel 26 to select an oven setting, such as “sous vide.” The user's choice may be communicated to the controlling elements 31 to then activate heating elements. The oven 10 may also be turned by supplying power to the oven 10. In configurations where the oven 10 is plugged into a wall outlet, the oven 10 may remain powered on at all times that a voltage is being supplied to the wall outlet.

The desired cooking parameters can then be entered at block 104. A user may select, for example, an oven cavity 14 temperature, a water bath 42 temperature, a type of cooking process, or a desired cooking time. In some configurations, a user may select these parameters using the display 30 or other buttons accompanying the display 30. The selections made by the user can be received by the controlling elements 31, which may alter an operational parameter of the heating element(s) present within the oven 10. The user may place the food containment system 44, 144, 244 within the cavity 76 of the water bath 42 and fill the cavity 76 with water. Additionally, the temperature sensor 48 can be suspended within the water bath 42 and placed in electrical communication with the controlling elements 31. Optionally, the food containment system 44, 144, 244 can contain one or more vacuum-sealed pouches of food when it is originally placed within the water bath 42. In some configurations, the oven 10 may prompt a user to verify that these items are present within the cavity 14 before the heating element(s) adjust operational parameters.

In some configurations, a sous vide cooking process is chosen by a user. The display 30 may prompt a user to enter the desired cooking parameters, which could include a water bath 42 temperature or total cooking time, for example. Optionally, the oven 10 may determine the appropriate water bath 42 temperature or cooking time based upon user input. For example, when a user selects a sous vide cooking process, the display may prompt the user to enter both the type and amount of food (e.g., weight, quantity, etc.) to be cooked. Based upon the values provided by the user, the controlling elements 31 can communicate with a local or external memory 33 to retrieve the target water bath 42 temperature and cooking time used to properly cook the food. In some configurations, the display 30 may also prompt a user to enter a desired doneness. For example, if a user was cooking a ribeye steak, the display 30 may prompt a user to choose between “rare,” medium rare,” “medium,” “medium well,” or “well done.” The subsequent selection by a user may affect the necessary cooking time or water bath temperature used by the oven 10 to cook the ribeye steak. Using the information supplied to the oven 10 by the user, the controlling elements 31 can establish a target water bath 42 temperature that will properly cook the food. In some configurations, the target water bath 42 temperature is approximately equal to a target finished temperature of the food. The controlling elements 31 or a user can then initiate rotation of the motor 46 automatically or manually (e.g., by pressing a push button present on the control panel 26). The motor 46 can begin operating, causing the turntable 40 to rotate about axis X-X.

With the cooking parameters selected at block 104, the heating element(s) can adjust the temperature within the oven cavity 14 until the target water bath 42 temperature is reached. In some configurations, a user may preheat the water within the water bath 42 using the one or more burners 24 on the cooktop 22 before placing the water bath 42 on the turntable 40. Once the temperature sensor 48 determines that the target water bath 42 temperature has been reached, the oven may alert a user that food can be placed within the water bath 42, if it is not already within the water bath 42. A user can then place one or more vacuum sealed pouches containing food within the water bath 42. In some configurations, the vacuum sealed pouches are placed within the food containment system 44, 144, 244, which submerges the pouches in a near constant position in the water bath 42 throughout the cooking process. Once the pouches are placed within the food containment system 44, 144, 244 and the food containment system 44, 144, 244 is received and at least partially submerged within the water bath 42, the turntable 40 can rotate about the turntable support 38 to agitate the water within the water bath 42. In some configurations, the water agitation caused by the food containment system 44, 144, 244 within the water bath 42 creates an approximately temperature-homogenous water bath 42. To promote additional agitation within the water bath 42, a motor and non-contact impeller may also be used. In some configurations, a submersible pump may be placed within the water bath 42 to drive additional agitation as well. In yet other configurations, a magnetic stir bar can be placed at the base of the water bath 42 to agitate the water.

Using the temperature sensor 48, the temperature of the water within the water bath 42 can be continuously monitored. In some configurations, the temperature sensor 48 can be programmed to measure the temperature of the water every 10 seconds, every second, or several times per second, for example. The temperature measurements taken by the temperature sensor 48 can then be communicated to the controlling elements 31. At decision block 106, the controlling elements 31 compare the water temperature measurements taken by the temperature sensor 48 to the target water bath 42 temperature. If the temperature sensor 48 detects that the water bath 42 temperature is incorrect, or not within a predetermined tolerance (e.g., ±1 degree F.), the oven cavity 14 temperature may need to be adjusted at block 108.

The oven cavity temperature may be adjusted in a number of ways. If the water bath 42 temperature measured is too low at block 106, the intensity of the heating element(s) can be increased. Additionally or alternatively, the cycling rate of heating elements may increase. In some configurations, the duty cycle of the heating elements may be increased as well so that more heat is inputted into the cavity 14 and the water bath 42. If the water bath 42 temperature measurement is too high, the intensity of the heating element(s) may be decreased. The cycling rates of heating elements and the duty cycles of heating elements may also be reduced. One or more convection fans may also increase or decrease the flow rate of air through the oven cavity 14. The oven cavity 14 temperature can be continuously corrected until the temperature of the water bath 42 is measured within the predetermined tolerance at decision block 106.

In some configurations, the oven 10 may maintain an approximately constant oven cavity 14 temperature during the preheating process, contrary to block 108. The oven cavity 14 temperature may remain constant, even when the water bath 42 temperature is measured to fall below the target water bath 42 temperature. Once the water bath 42 temperature is measured within the predetermined tolerance from the target water bath 42 temperature, the preheating process will be complete, and the process 100 can continue from decision block 106.

If the water bath 42 temperature is calculated within the tolerance from the target water bath 42 temperature, the controlling elements 31 may then determine whether the user-entered cooking time has elapsed at decision block 110. In some configurations, a user enters the desired cooking time for the sous vide process at block 104, which is stored in a local or external memory 33. The controlling elements 31 may actively monitor the duration of the sous vide cooking process, and can compare the entered cooking time with the elapsed cooking time. If the elapsed cooking time is less than the entered cooking time (e.g., 30 minutes has elapsed and the entered cooking time is 60 minutes), the process can proceed to block 112, where the oven cavity 14 temperature can be maintained. By maintaining the oven cavity 14 temperature, the water bath 42 temperature will remain approximately constant and within the acceptable tolerance from the target water bath 42 temperature. Typically, oven temperatures around 50 degrees higher than the target water bath 42 temperature have been sufficient to maintain a constant water temperature within the water bath 42. The process can then return to decision block 106, where the water bath 42 temperature is actively monitored.

If the controlling elements 31 determine that the set cooking time has elapsed at decision block 110, an alert may be initiated at block 114. The alert may be a visual or auditory alarm, for example. A user may then remove the water bath 42 or the food contained within the water bath 42 to consume it. In some configurations, after the alert is initiated at block 114, the process returns to block 112 and the temperature of the water bath 42 and oven cavity 14 continue to be actively monitored and adjusted. If the correct target water bath 42 temperature is chosen at block 104, the sous vide cooking process can continue indefinitely, beyond the set cooking time, without the risk of overcooking food. The target water bath 42 temperature can be equal to the desired food temperature, so that continued exposure to the water bath 42 at the same temperature (e.g., 120 degrees F.) will not overcook the food. In fact, extended exposure to the target water bath 42 temperature has succeeded in killing bacteria throughout the food while tenderizing many meat products. Alternatively, the motor 46 and heating element(s) may cease operation when the set cooking time has elapsed. In other configurations, the heating process may be reduced or otherwise altered to end the cooking process but continue heating the food.

Although turntable support 38, turntable 40, and motor 46 are discussed as being components of the sous vide assembly 36 that may be present within an oven 10, these features can be utilized by the oven 10 in other cooking processes. For example, the turntable 40 may advantageously rotate during a baking process. In other cooking operations, the turntable 40 may rotate between about 1 rpm and about 30 rpm, which may be suitable for agitating the contents of a container 42 over a period of time. This may simplify a cooking process that would typically require a user to stir or otherwise mix the components within a container 42 periodically over time. For example, if a user is making a stock in the oven 10, the turntable could rotate between about 3 rpm and about 18 rpm to agitate the liquid inside the container 42.

Using the sous vide oven 10 and sous vide cooking process 100 described above, accurate (e.g., within about 1 degree F.) sous vide cooking can be performed. The oven 10 actively monitors the water temperature within the water bath 42 and adjusts the heating elements present within the oven 10 to either lower, raise, or maintain the temperature within the oven cavity 14. Using the motor 46 or other agitation mechanisms discussed above, the water temperature can be homogenously distributed about the entire water bath 42. The heating process 100 can continue indefinitely, so sous vide cooking processes taking multiple hours can be readily performed.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An oven adapted to perform a sous vide cooking process, the oven comprising:
an oven body defining an oven cavity;
a heating element positioned within the oven and controlled by a controlling element;
a container placed upon a rotatable table within the oven cavity, the container having an outer wall defining a cavity adapted to receive liquid; and
a temperature sensor extending into the cavity adapted to receive liquid, the temperature sensor being in electrical communication with the controlling element and the heating element.

2. The oven of claim 1, wherein the table is removably coupled to a table support and the table support has a frame coupled to a wall of the oven cavity.

3. The oven of claim 2, wherein the table support comprises a shaft driven by a motor external from the oven cavity, the shaft rotating about a first axis.

4. The oven of claim 3, wherein a first bevel gear is coupled to a distal end of the shaft and wherein a bottom surface of the table comprises a second bevel gear coupled to the first bevel gear, and rotation of the first bevel gear about the first axis induces rotation of the second bevel gear about a second axis perpendicular to the first axis.

5. The oven of claim 1, wherein a food containment system is removably received within the cavity adapted to receive liquid.

6. The oven of claim 1, wherein the oven body comprises a cooktop having one or more gas burners.

7. The oven of claim 1, wherein the temperature sensor is of a type chosen from the group consisting of thermometers, thermocouples, and resistive temperature devices (RTD).

8. The oven of claim 1, wherein the controlling element comprises a controller configured to receive a target temperature, compare a temperature measured by the temperature sensor to the target temperature, and adjust an operational parameter of the heating element based upon the calculated difference between the target temperature and the temperature measured by the temperature sensor.

9. A method of sous vide cooking within an oven defining an oven cavity heated by a heating element in communication with a controlling element, the method comprising:
measuring a water temperature of water within a container in the oven cavity using a temperature sensor in communication with the controlling element;
comparing the measured water temperature to a target water temperature provided to the controlling element; and
adjusting an operational parameter of the heating element based upon a calculated difference between the measured water temperature and the cooking water temperature.

10. The method of claim 9, wherein the method further comprises the step of agitating the water within the container by rotating the container about a first axis.

11. The method of claim 10, wherein the container is placed upon a rotating table removably coupled to a shaft, the shaft being driven by a motor external to the oven cavity and configured to rotate about a second axis perpendicular to the first axis.

12. The method of claim 9, wherein the method further comprises the step of providing a target cooking time to the controlling element.

13. The method of claim 12, wherein the method further comprises measuring an elapsed cooking time and comparing the elapsed cooking time to the target cooking time, and issuing an alert when the elapsed cooking time and the target cooking time are equal.

14. The method of claim 9, wherein the step of providing a target water temperature to a controlling element is performed by entering a type of food to be cooked into the controller, the controlling element then accessing a memory containing the target water temperature associated with the type of food to be cooked that was entered.

15. The method of claim 14, wherein the step of entering the type of food to be cooked into the controlling element is performed by a user interacting with a display in communication with the controlling element.

16. The method of claim 14, wherein the memory containing the target water temperature associated with the type of food is located external from the oven.

17. The method of claim 9, wherein the step of measuring the water temperature of water within the container is performed by partially submerging the temperature sensor within the water.

18. The method of claim 9, wherein a convection fan is positioned near the heating element to disperse heat about the oven cavity.

19. The method of claim 9, wherein the method comprises submerging a vacuum-sealed pouch in the water.

20. The method of claim 19, wherein the method comprises situating the vacuum-sealed pouch within a wire-mesh bag submerged within the container.
